(19) United States
(12) Patent Application Publication
(10) Pub. No.: US 2005/0247538 A1
(43) Pub. Date: Nov. 10, 2005

(54) Vehicle clutch

(76) Inventors: Bernd Dobele, Salem (DE); Wilhelm Hardtle, Markdorf (DE); Karl-Fritz Heinzelmann, Meckenbeuren (DE); Christoph Ruchardt, Bodolz (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/526,215

(22) PCT Filed: Aug. 30, 2003
(86) PCT No.: PCT/EP03/09650

§ 371 Date: Mar. 4, 2005

(30) Foreign Application Priority Data
Sep. 7, 2002 (DE) 102 41 508.0

(51) Int. Cl. B60K 17/02

(52) U.S. Cl. 192/105 B; 192/111 A

(57) ABSTRACT

One vehicle clutch (6) is situated in a vehicle between a prime mover (2) and a transmission (4) and is controlled according to the rotational speed of the prime mover (2). As centrifugal clutch, the vehicle clutch (6) has elements (26, 32) which cause a variable torque transmission according to the rotational speed of the prime mover (2). The vehicle clutch (6) is actuatable without an externally actuated actuator, is the only clutch located between prime mover (2) and transmission (4) and is provided as starting clutch without possibility of interruption of traction during shifting operations.

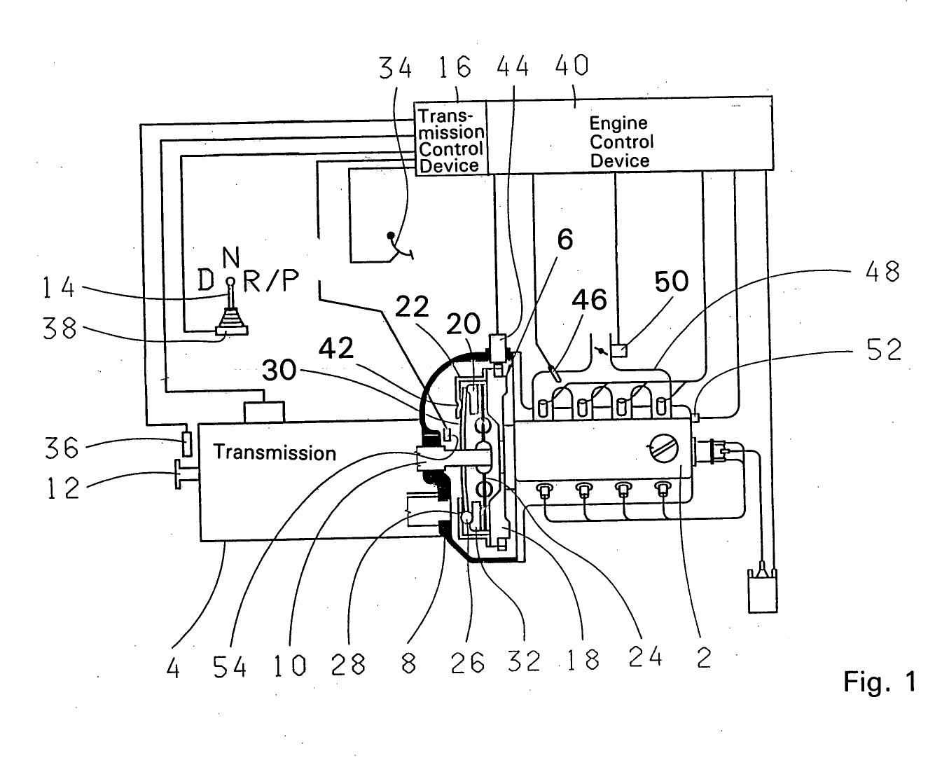

In a vehicle, one clutch is usually inserted between a prime mover and a transmission which is to assume two functions. On one hand, the vehicle clutch serves to start off the vehicle which, at first, was open increasingly closing via a slipping intermediate state while the vehicle starts moving whereby more and more torque is transmitted until finally the vehicle clutch is fully closed and the complete torque is transmitted by the prime mover to the transmission. On the other hand, while moving, in order to change the gear wheel ratio, the vehicle clutch serves to loosen the force-locking connection between prime mover and transmission in order, later after the change, to become closed again either quickly or gradually depending on the driving mode.

Such a vehicle clutch has been disclosed in DE 37 30 565 A1, the object of which is to be considered fully contained in this application. One clutch is situated between a prime mover and a transmission and works as centrifugal clutch in the starting process. In a change of gear, the clutch has to be externally actuated by an actuator via a corresponding linkage. This requires a separate actuator with appertaining transmission device to the clutch and an actuation device connected therewith on the clutch.

The problem on which the invention is based is to simplify a vehicle clutch between the prime mover and the vehicle transmission.

The problem is solved by a vehicle clutch having the features of claim 1. Developments are object of sub-claims.

One vehicle clutch is situated in a vehicle between a prime mover and a transmission. It is controlled according to the rotational speed of the prime mover and, should it be the case, to a rotational speed signal of the transmission, such as the input shaft rotational speed or the output shaft rotational speed of the transmission. Depending on the rotational speed of the prime mover, elements in the form of a centrifugal clutch cause a variable torque transmission. With the aid of the rotational speed signals, when starting off, an acceleration of the vehicle, according to the accelerator pedal angle, is adjusted by the centrifugal action of the elements thereby producing the friction torque needed. During low rotational speeds in the engine idling speed or at an input shaft rotational speed or output shaft rotational speed of the transmission close to stoppage, the clutch automatically opens due to the weak abutting centrifugal forces which in principle depend on the rotational speed. The vehicle clutch is actuated only via the centrifugal forces. An actuator, which externally adjusts the clutch, is not provided. The vehicle clutch is the only clutch located between the prime mover and the transmission and in the shifting operations acts only as a starting clutch without the possibility of interruption of the tractive forces. A separating clutch is not provided for interrupting the traction and the torque transmission in a shifting operation during motion. Devices are preferably provided for monitoring the rotational speed of a part on the input side of the vehicle clutch and of a part on the output side of the vehicle clutch so that rotational speed differences in the clutch can be shown. Too strong of an acceleration of the clutch by the prime mover, the same as too strong pressing of the engine rotational speed due to feedbacks from the output side of the clutch or of the transmission, are prevented by the rotational speeds being monitored and, if necessary, eliminating the abnormal condition by an active control of the prime mover by taking back the injection amount or, should it be the case, a temporarily limited increase of the injection amount or by a change of the gear ratio. In an advantageous development, an electronic device is provided in which the friction work of the vehicle clutch can be calculated and which is connected with the devices for monitoring the rotational speeds. The friction work is calculated, for example, by multiplying the rotational speed difference between the input side and the output side of the clutch by the torque transmitted by the clutch. By taking a time component into account, the friction work can be determined therefrom. The transmitted torque depends on the rotational speed of the prime mover and can be determined by an adequate algorithm, not an object of the invention, in which as input parameters are factored in the rotational speed of the prime mover, the transmission input rotational speed, the transmission output rotational speed, the vehicle velocity, the actual engine torque and the parameters derived therefrom. In one other advantageous development in the electronic control device a characteristic field or a similar logic is stored by way of which the rotational speed of the prime mover can be influenced and which comprises the retalationships of values for accelerator pedal position, injection amount and engine rotational speed. If necessary other parameters like vehicle weight and load condition of the clutch must be taken into account.

Due to the very great differences in weight between an empty and a loaded vehicle, specially in the case of industrial vehicles, it will be difficult to find a coordination adequate for all vehicle conditions. In case of a heavy vehicle it can be the case that the clutch transmits enough torque only at very high rotational speeds in order sufficiently to accelerate the vehicle and thus great differences of rotational speeds appear on the clutch whereby a great friction work and consequently high wear are to be expected. An engine control in the form of withdrawing the injection amount can, according to the case, reduce the differential rotational speeds, but then the slipping time increases which results in poor acceleration behavior on account of weak transmissible torque and in great friction work. Therefore, in a specially advantageous development, the clutch has with its elements causing the torque transmission kinematics which can be controlled according to the vehicle weight or tractional resistance. The kinematics preferably comprises at least one changeable lever element, the changeable lever ratios of which serve to control the torque transmission capacity of the clutch. The lever ratios on the lever elements, by displacement of the reversal points on the levers, can be advantageously changed electromotively, electromagnetically, hydraulically or pneumatically. In a specially advantageous embodiment, the vehicle clutch has a compensation of wear on the torque transmitting capacity for which purpose can be specially provided the changeable lever elements. The electronic control device of the vehicle clutch is advantageously integrated in a control device of the transmission or of the whole vehicle. Such a vehicle clutch can be particularly used between a prime mover and an automated vehicle transmission.

A neutral position of the transmission while the vehicle is stationary is no longer needed since the vehicle clutch opens automatically and with certainty.

An added wiring, power supply and vehicle installation for a clutch actuator can be eliminated in the vehicle. The design of the transmission rear-mounted on the vehicle clutch is arbitrary and thus transmissions having one or more countershafts can likewise be used such as transmissions with one or more front-mounted or rear-mounted auxiliary transmissions like splitter group transmissions and range change group transmissions.

The use of power take offs on the transmission remains fully operable with the proposed vehicle clutch. When the vehicle is stationary, the transmission is shifted to neutral. The power take off can be engaged then. If the prime mover is now accelerated, the clutch closes and transmits torque to the transmission and thus to the power take off. The same applies to intermittent power take offs which are operated with engaged gear.

The invention is explained in detail with the aid of a drawing.

One embodiment of the invention is shown in the drawing with reference to a diagrammatic longitudinal section through a multi-step transmission. The numeral 2 collectively designates a vehicle engine in the drawing and the numeral 4 a transmission designed as multi-step transmission, while the numeral 6 indicates a clutch placed between the engine 2 and the transmission 4. With the reference numeral 8 is shown one housing that encloses the transmission 4. One transmission input shaft is indicated with the numeral 10 and one transmission output shaft with the numeral 12.

A transmission selector lever 14 is connected with a transmission control device 16. In the embodiment shown here with said selector lever 14 are coordinated only three positions, namely, a middle neutral position N, a normal forward position D, to which all forward gears of the transmission are shifted automatically and one reverse position RIP which offers at the same time a parking lock when the vehicle is stationary.

The clutch collectively designated with the numeral 6 in the drawing is designed as friction disc clutch which has one clutch plate 18 rigidly connected with the crankshaft, not shown here, of the engine 2 and one clutch pressure plate 20 which is held non-rotatably but axially movably against the clutch plate 18 or a clutch cover 22 fastened thereon. Between the clutch plate 18 and the clutch pressure plate 20 are situated the friction discs of one clutch disc 24 rigidly held upon the transmission input shaft 10. A plate spring 30 known per se, which is tiltingly supported in a central diameter area on a bearing cam 42 of the clutch cover 22, presses with its radially outer edge against the clutch pressure plate 20.

The contact force required for engaging the clutch 6 is produced by centrifugal force. To that end on the periphery are provided uniformly distributed centrifugal weights in the form of cylindrical rollers 26 rotatably supported on cylindrical bolts and radially adjustably passed into radial slots 28 of the clutch cover 22 gripping by adequate recesses in the plate spring 30. The cylindrical rollers 26, the bearing bolts of which support themselves on the edges of the slots 28 upon the clutch cover 22, here roll off upon conductor ramps 32 of the clutch pressure plate 20 which extend diagonally to the radial direction. When the rotational speed of the crankshaft increases with simultaneous increasing radial migration of the cylindrical rollers 26 due to the centrifugal force, the axial contact force exerted upon the clutch pressure plates 20 via the conductor ramp 32 increases so that the clutch 6 is actuated increasingly in engagement direction.

If the stationary vehicle equipped with such a multi-step transmission 4 has now to be started, the rotational speed of the prime mover 2 is boosted by actuation of an accelerator pedal indicated with 34, there resulting an automatic, rotational-speed dependent engagement of the clutch 6 due to the action of the cylindrical rollers 26 subjected to centrifugal force and which as the engine rotational speed increases are more and more outwardly pushed pressing the clutch pressure plate 20 against the clutch plate 18 whereby the friction discs of the clutch disc 24 located between the two plates are induced to produce a frictional engagement between the crankshaft and the transmission input shaft 10. Since the transmission selector lever 14 had first been brought to the position D or R/P, i.e., to the forward or reverse driving position, the first forward or the reverse gear of the multi-step transmission 4 is also engaged and the vehicle can start depending on the frictional engagement building up on the clutch 6.

At speeds of the vehicle that become lower, the clutch actuated by centrifugal force again opens, for example, when required by the traffic the vehicle has to hold or even stop. On the other hand, no clutch actuation takes place any more during the remaining shifting operations of the transmission, since said shifting operations are automatically carried out at the actual synchronization point of the associated vehicle gear wheels. The individual shifting operations are here released by the transmission control device 16 which for the purpose receives a signal corresponding to the speed of the vehicle from a rotational speed sensor 36 that detects the rotational speed of the transmission output shaft 12. Besides, coordinated with the selector lever 14, a position sensor 38 can be provided which communicates to the transmission control device 16 a signal about the speed range adjusted with the selector lever 14. One other signal line connects the transmission control device 16 with the accelerator pedal 34 of the vehicle. The transmission control device 16 can also receive other signals required for control of the transmission from an engine control deice 40 connected therewith to form one homogeneous control device which controls, for example, the ignition and fuel supply to the vehicle engine 2. This engine control device 40 or the transmission control device 16 receives from a rotational speed sensor 44 further measuring signals about the rotational speed of the crank shaft, the same as from a pressure sensor 46 about the power-dependent vacuum in the suction pipe 48. Other measure sensors can be a position sensor 50 detector of the position of the throttle valve, the same as a temperature sensor 52 detector of the engine temperature. The rotational speed of the input shaft 10 of the transmission 4 is detected by a rotational speed sensor 54 and transmitted to the transmission control device 16.

### REFERENCE NUMERALS

2 vehicle engine
4 transmission
6 clutch
8 housing
10 transmission input shaft
12 transmission output shaft
14 transmission selector lever
16 transmission control device
18 clutch plate
20 clutch pressure
22 clutch cover
24 clutch disc
26 cylindrical rollers
28 slot
30 plate spring
32 conductor ramp
34 accelerator pedal
36 rotational speed sensor
38 position sensor
40 engine control device
42 bearing cam
44 rotational speed sensor
46 pressure sensor
48 suction pipe
50 position sensor
52 temperature sensor
54 rotational speed sensor

1-12. (canceled)

13. A vehicle clutch (6) located in a vehicle between a prime mover (2) and a transmission (4) and controlled according to a rotational speed of the prime mover (2), the clutch having elements (26, 32) which cause transmission of a variable torque according to the rotational speed of the prime mover (2), the vehicle clutch (6) being actuatable without an externally actuated actuator and the elements (26, 32) causing the torque transmission having kinematics controllable according to vehicle weight or transactional resistance, the kinematics comprising changeable lever elements, changeable lever ratios of which serve to control a capacity for torque transmission of said vehicle clutch (6) and the lever ratios on the lever elements can be one of electromotively, electromagnetically, hydraulically and pneumatically changed:

14. The vehicle clutch (6) according to claim 13, wherein said vehicle clutch has a wear compensation.

15. The vehicle clutch (6) according to claim 14, wherein the changeable lever elements are provided for compensation to the wear.

16. The vehicle clutch (6) according to claim 13, wherein the vehicle clutch is located between the prime mover (2) and an automated vehicle transmission (4).
